(19) United States
(12) Patent Application Publication
(10) Pub. No.: US 2026/0264587 A1
(43) Pub. Date: Sep. 10, 2026

(54) SIDE IMPACT PROTECTION DEVICE FOR A CHILD SAFETY SEAT IN A CAR AND A CHILD SAFETY SEAT

(71) Applicant: NINGBO YUANYUAN AUTO ACCESSORIES CO., LTD, Cixi City (CN)

(72) Inventor: Xijiong FU, Cixi City (CN)

(21) Appl. No.: 19/322,582

(22) Filed: Sep. 8, 2025

(30) Foreign Application Priority Data
Mar. 6, 2025 (CN) 202520393660.4

(51) Int. Cl. B60N 2/28

(52) U.S. Cl. CPC B60N 2/2884; B60N 2/2827

(57) ABSTRACT

A side impact protection device for a child safety seat in a vehicle comprises: a base; an adjustment assembly; and an anti-collision member. The device is characterized in that: the adjustment assembly comprises a knob and a screw; the base is provided with a screw hole threadedly engaged with the screw; the anti-collision member is provided with a mounting hole, the adjustment assembly is movably inserted into the mounting hole, and an axial limit structure is provided between the anti-collision member and the adjustment assembly.

### TECHNICAL FIELD

The present invention relates to a side impact protection device for a child safety seat in a car.

### BACKGROUND ART

A child safety seat is a seat installed on a car seat specifically for protecting children. Typically, child safety seats are installed in the rear seat, especially near the vehicle door. A side impact protection device is required to prevent the safety seat from being hit. The side impact protection device absorbs most of the energy generated by the impact, thereby reducing the impact force on the safety seat and the child in the seat. Currently, most side impact protection devices on the market are decorative blocks installed on one side of the safety seat. These blocks are directly molded onto the outer surface of the safety seat or fixedly connected to the outer surface. Therefore, the distance between the side impact protection device and the outer surface of the child safety seat cannot be adjusted. Furthermore, since the impact surface of the side impact protection device must protrude relative to the side of the seat, it is more likely to collide with the vehicle body first. This fixed device requires design based on the installation location and the shape of the seat side, which is quite complex.

To address the above issues, existing technology, such as the Chinese utility model patent No. ZL201822178905.4 (publication No. CN209257923U), "Side Impact Protection Assembly and Child Safety Seat," discloses a side protection assembly with an adjustable distance between the vehicle door and the anti-collision component. A screw is fixed to the inside of the anti-collision component. The user rotates the anti-collision component to adjust the screw's threaded depth within the threaded hole, thereby controlling the lateral distance between the anti-collision component and the base. The screw can be adjusted based on the protrusion of the seat side, ensuring that the distance between the outer side of the anti-collision component and the vehicle door is always greater than the distance between the seat side and the door, thereby adapting to seats with different side shapes.

In reality, to increase sales of child safety seats, the shape of the bumper is often designed to suit customer needs. The aforementioned patent uses a rotating bumper to adjust the distance between the bumper and the vehicle door. However, the center of gravity of these differently shaped bumpers is not necessarily aligned with the screw's rotational axis. During rotation, the constantly changing center of gravity can cause the screw to tilt outward relative to the axis, causing it to press against the internal threads of the screw hole. This can lead to the screw becoming stuck in the hole, hindering user comfort.

### SUMMARY OF THE UTILITY MODEL

The first technical problem addressed by this utility model is to provide a side impact protection device with a stable center of gravity during rotational adjustment of the bumper, allowing for more stable adjustment.

The second technical problem addressed by this utility model is to provide a child safety seat incorporating such a side impact protection device, addressing the aforementioned prior art.

The present invention solves the first technical problem by employing a technical solution: the side impact protection device of the child safety seat is mounted on the outer surface of the safety seat and comprises: a base fixedly connected to the safety seat; an adjustment assembly movably disposed within the base; an anti-collision member, mounted on the base via the adjustment assembly, capable of adjusting the distance between the anti-collision member and the base, and thereby adjusting the distance between the anti-collision member and the outer surface of the safety seat.

The present invention is characterized in that: the adjustment assembly comprises a knob for applying an external force and a screw fixedly connected to the knob; the base is provided with a screw hole that engages with the screw thread, and the knob is capable of driving the screw to rotate along the thread in the screw hole; the anti-collision member is provided with a mounting hole, the adjustment assembly movably disposed within the mounting hole, and an axial stopper is provided between the anti-collision member and the adjustment assembly, so that when the knob is rotated by external force and the screw rotates along the thread in the screw hole, the adjustment assembly drives the anti-collision member to translate axially outward or inward, thereby moving the anti-collision member axially away from or closer to the base.

To enhance the stability of the axial connection structure and the bumper assembly, the axial stop structure further comprises: A first, annular stopper formed by a circumferentially outwardly protruding outer wall of the knob; A second, annular stopper formed by a circumferentially outwardly protruding end of the screw rod proximal to the bumper. The first and second stoppers are spaced axially apart.

A stopper protrudes inwardly from the inner wall of the bumper assembly's mounting hole, and the stopper protrudes movably within the gap between the first and second stoppers. The stopper protrusion is movably engaged between the first and second stoppers, ensuring that the bumper assembly can move axially while the adjustment assembly drives the bumper without rotating with the knob and screw rod.

To prevent damage to the safety seat and bumper during inward adjustment, the outer diameter of the second connection portion is larger than the diameter of the screw hole. When the bumper is adjusted to its closest position to the base, the second stopper abuts against the base at the outer edge of the screw hole's opening. The second stopper abuts against the screw hole, preventing the user from further inward rotation of the adjustment assembly. This prevents the inner side of the bumper from contacting the base, and the end of the screw distal from the bumper from contacting the safety seat.

To prevent the adjustment assembly from rotating the bumper with it, the screw further includes an annular connecting portion protruding axially from its connection with the knob. This connecting portion is located between the first and second stopper portions, and a gap is left between the connecting portion and the stopper protrusion to allow the adjustment assembly to rotate relative to the bumper.

This gap prevents circumferential contact and friction between the connecting portion and the stopper protrusion during rotation. To prevent radial displacement of the bumper during rotational adjustment, the bumper further includes a radial stopper protruding axially from the peripheral edge of the mounting hole opening.

The first and second stopper portions cooperate with the radial stopper structure to maintain the relative radial position of the adjustment assembly and the bumper when the knob is rotated by external force, causing the screw to rotate along the threads in the screw hole. The radial limiting structure can restrict radial movement of the anti-collision member relative to the knob, further stabilizing the anti-collision member's center of gravity.

To limit radial movement of the axial limiting structure, the radial limiting structure further comprises: A first limiting bead, formed by an axially outwardly projecting edge of the anti-collision member at the mounting hole opening. The inner diameter of the first limiting bead matches the outer diameter of the first limiting portion, and the outer edge of the first limiting portion abuts against the inner wall of the first limiting bead; A second limiting bead, formed by an axially inwardly projecting edge of the anti-collision member at the mounting hole opening.

The inner diameter of the second limiting bead matches the outer diameter of the second limiting portion, and the outer edge of the second limiting portion abuts against the inner wall of the second limiting bead. The first limiting bead radially limits the first limiting portion, and the second limiting bead radially limits the second limiting portion. To stabilize the axial translation of the bumper, a guide post is further provided axially on the inner side of the bumper, near the base. The base has a guide hole corresponding to the guide post, and the guide post fits snugly into the guide hole. The fit between the guide post and the guide hole stabilizes the bumper's translational trajectory and further prevents the bumper from rotating with the adjustment assembly.

To prevent the screw from being disengaged when the user adjusts the bumper outward, a third stopper is further formed on the other end of the screw near the bumper, protruding outwardly. The outer diameter of the third stopper is larger than the diameter of the screw hole. When the bumper is adjusted to its maximum distance from the base, the third stopper abuts the base at the inner edge of the screw hole. When the third stopper abuts the base at the inner edge of the screw hole, the user cannot further rotate the knob outward, preventing the screw from disengaging from the screw hole.

Furthermore, the knob has a first connecting hole formed therein, and the screw has a second connecting hole connected to the first connecting hole formed therein. A fastener is inserted through the connection between the first and second connecting holes, and the fastener securely connects the knob to the first connecting hole so that the two can rotate synchronously.

The technical solution employed by the present invention to solve the second technical problem is as follows: The child safety seat includes a seat body, characterized in that the outer surface of the seat body is provided with the aforementioned side impact protection device, the outer surface of the seat body is recessed with a mounting groove, the side impact protection device is securely connected to the bottom of the mounting groove, and the groove wall of the mounting groove is adapted to the shape of the anti-collision member.

Compared with the existing technology, the advantages of the present invention are:
1. The side impact protection device of the present invention utilizes an axial limit structure provided between the bumper and the adjustment assembly, enabling the adjustment assembly to drive the bumper to translate axially outward or inward. This translational motion stabilizes the center of gravity of the bumper, preventing the screw from becoming stuck in the screw hole due to the constantly changing center of gravity of the bumper during rotational adjustment of bumpers of various shapes. This enhances adaptability to bumpers of varying shapes and ensures more stable rotational adjustment.
2. The child safety seat of the present invention has a recessed mounting groove on the outer surface of the seat body. When the user adjusts the bumper outward, the groove wall, which matches the shape of the bumper, also limits the rotational motion of the bumper, further stabilizing the axial translational motion of the bumper.

### BRIEF DESCRIPTION OF THE DRAWINGS

FIG. 1 is a schematic diagram of the side impact protection device of Example 1 of the present invention installed on the outer surface of a safety seat;

FIG. 2 is a partially enlarged view of a cross-sectional view of the connection between the side impact protection device and the safety seat of Example 1 of the present invention;

FIG. 3 is a cross-sectional view of the side impact protection device of Example 1 of the present invention;

FIG. 4 is a partially enlarged view of the circled area in FIG. 3;

FIG. 5 is an exploded view of the side impact protection device of Example 1 of the present invention;

FIG. 6 is a schematic diagram of the internal structure of the side impact protection device of Example 1 of the present invention;

FIG. 7 is an exploded view of the child safety seat of Example 2 of the present invention.

### DETAILED DESCRIPTION

The present invention will be described in further detail below with reference to the accompanying drawings and embodiments.

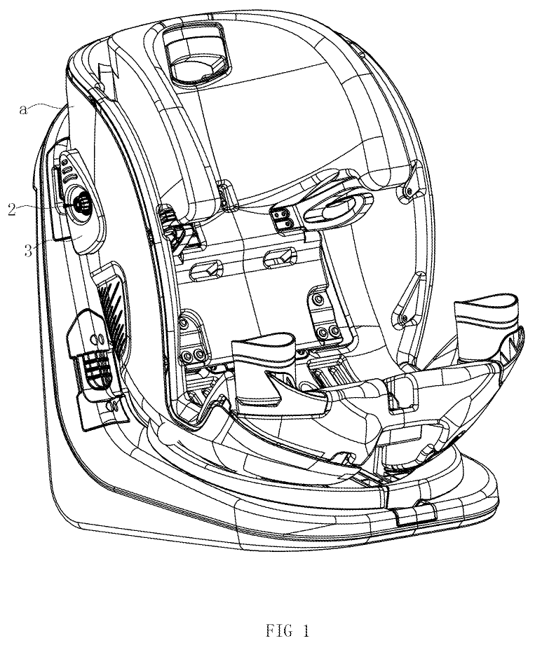

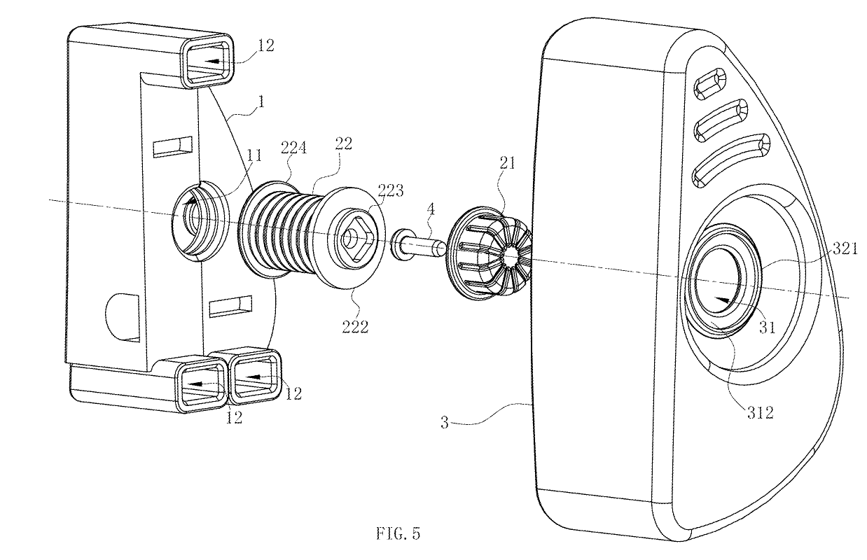

FIGS. 1 to 6 illustrate a preferred embodiment of the present invention. The side impact protection device of this embodiment is installed on the outer surface of a child safety seat in a car, primarily to reduce impact forces on the car seat and the child in the car seat.

To meet the aesthetic needs of different users, the impact protection member needs to be designed in various shapes. Conventional methods use a screw to adjust the distance between the impact protection member and the vehicle door. However, the center of gravity of the impact protection member of various shapes is not necessarily on the rotation axis, and the screw is prone to getting stuck in the screw hole.

Therefore, it would be beneficial to provide a side impact protection device that stabilizes the center of gravity of the impact protection member during rotational adjustment, allowing for more stable adjustment.

The detailed structure of the side impact protection device of this child safety seat is described below:

Referring to FIGS. 1 to 5, the side impact protection device of this embodiment is installed on the outer surface of a child safety seat A, and includes a base 1 fixedly connected to the child safety seat A, an adjustment member movably disposed within the base 1, and a plurality of adjustment members. The anti-collision member 3 is provided on the base 1 via the adjustment assembly 2. The distance between the anti-collision member 3 and the base 1 can be adjusted by the adjustment assembly 2, thereby adjusting the distance between the anti-collision member 3 and the outer surface of the safety seat A. The adjustment assembly 2 includes a knob 21 for applying an external force and a screw 22 fixedly connected to the knob 21. The base 1 is provided with a screw hole 11 that threadably engages with the screw 22. The knob 21 can drive the screw 22 to rotate along the threads in the screw hole 11. The anti-collision member 3 is provided with a mounting hole 31, and the adjustment assembly 2 is movably inserted into the mounting hole 31. An axial limit structure is provided between the anti-collision member 3 and the adjustment assembly 2. When the external force drives the knob 21 to rotate and the screw 22 to rotate along the threads in the screw hole 11, the adjustment assembly 2 drives the anti-collision member 3 to move axially outward or inward, thereby moving the anti-collision member 3 axially away from or closer to the base 1.

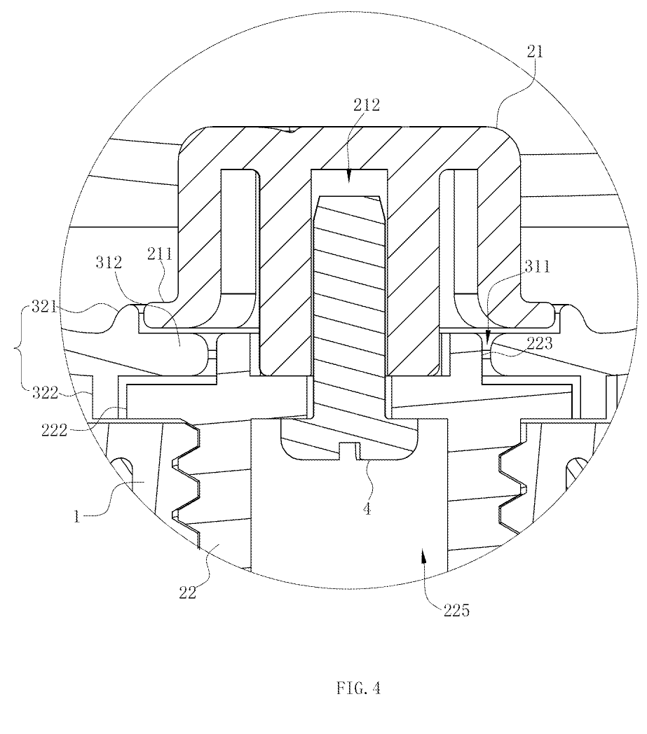

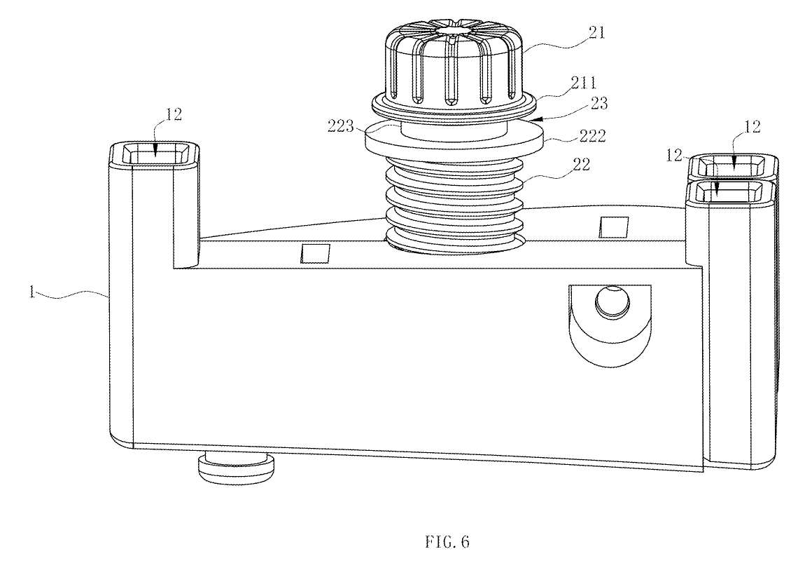

Referring to FIGS. 4 and 6, the axial limiting structure includes a first limiting portion 211, formed by a circumferential outward projection from the outer wall of the knob 21, and a second limiting portion 222, formed by a circumferential outward projection from the end of the screw 22 proximate the bumper 3. An axial gap 23 is formed between the first limiting portion 211 and the second limiting portion 222. A limiting protrusion 312 protrudes inward from the inner wall of the mounting hole 31 of the bumper 3. This limiting protrusion 312 is movably engaged within the gap 23 between the first limiting portion 211 and the second limiting portion 222.

By movably engaging the limiting protrusion 312 between the first limiting portion 211 and the second limiting portion 222, the adjustment assembly 2 drives the bumper 3 to move axially without rotating with the knob 21 and screw 22, thereby enhancing the stability of the axial connection structure and the bumper 3.

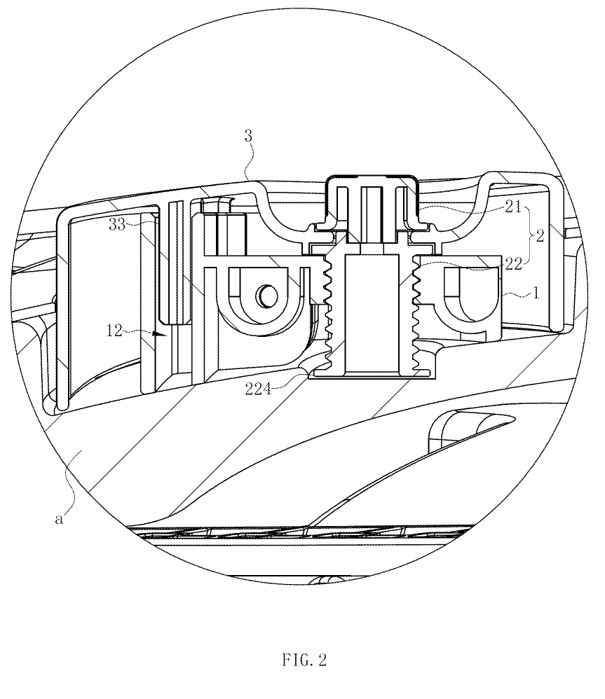

As shown in FIG. 2, the outer diameter of the second connecting portion 222 is larger than the diameter of the screw hole 11. When the bumper 3 is adjusted to its closest position to the base 1, the second stop 222 abuts the base 1 at the outer edge of the screw hole 11. This abutment between the second stop 222 and the screw hole 11 prevents the user from further rotating the adjustment assembly 2 inward. This prevents the inner surface of the bumper 3 from contacting the base 1, and the end of the screw 22 away from the bumper 3 from contacting the safety seat A. This further prevents damage to the safety seat A and the bumper 3 during inward adjustment.

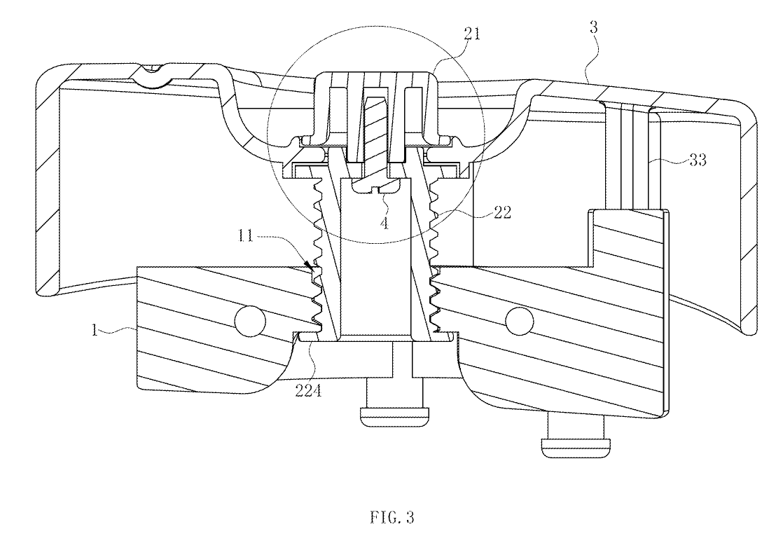

As shown in FIG. 3, the screw 22 has an annular connecting portion 223 axially extending from its connection with the knob 21. The connecting portion 223 is located between the first stop 211 and the second stop 222. A gap 311 is provided between the connecting portion 223 and the stop protrusion 312 to allow the adjustment assembly 2 to rotate relative to the bumper 3. The gap 311 prevents circumferential contact and friction between the connecting portion 233 and the limiting protrusion 312 during rotation, thereby preventing the adjustment assembly 2 from rotating the anti-collision member 3.

Referring to FIG. 4, the anti-collision member 3 has a radial limiting structure 32 formed axially on the periphery of the opening of the mounting hole 31. The first limiting portion 211 and the second limiting portion 222 cooperate with the radial limiting structure 32 to ensure that the relative radial position of the adjustment assembly 2 and the anti-collision member 3 remains unchanged when the knob 21 is rotated by an external force and the screw 22 rotates along the threads in the screw hole 11. The radial limiting structure 32 limits radial movement of the anti-collision member 3 relative to the knob 21, further stabilizing the center of gravity of the anti-collision member 3 and ensuring that the anti-collision member 3 does not deviate radially during rotational adjustment.

The radial limiting structure 32 includes a first limiting bead 321 and a second limiting bead 322. The first limiting bead 321 is formed by an axially outwardly protruding edge of the anti-collision member 3 at the opening of the mounting hole 31. The inner diameter of the first limiting bead 321 matches the outer diameter of the first limiting portion 211, and the outer edge of the first limiting portion 211 abuts against the inner wall of the first limiting bead 321. The second limiting bead 322 is formed by an axially inwardly protruding edge of the anti-collision member 3 at the opening of the mounting hole 31. The inner diameter of the second limiting bead 322 matches the outer diameter of the second limiting portion 222, and the outer edge of the second limiting portion 222 abuts against the inner wall of the second limiting bead 322.

The first limiting bead 321 radially limits the first limiting portion 211, while the second limiting bead 322 radially limits the second limiting portion 222, thereby limiting radial movement of the axial limiting structure. The anti-collision member 3 is provided with a guide post 33 axially on the inner side of the base 1. The base 1 is provided with a guide hole 12 corresponding to the guide post 33. The guide post 33 and the guide hole 12 are adapted and slidably matched. The cooperation between the guide post 33 and the guide hole 12 stabilizes the translation trajectory of the anti-collision member 33 and the axial translation movement of the anti-collision member 3. At the same time, it can further prevent the anti-collision member 3 from interfering with the adjustment component.

The knob 21 defines a first connection hole 212, and the screw 22 defines a second connection hole 225 that communicates with the first connection hole 212. A fastener 4 extends through the connection between the first and second connection holes 212, 225. The fastener 4 securely connects the knob 21 to the first connection hole 212, enabling them to rotate synchronously.

The side impact protection device of the child safety seat of this embodiment can perform the following actions: 1) Outward Adjustment: When the user rotates the knob 21 outward, the screw 22 moves outward along the internal threads of the screw hole 11. The axial limit structure drives the anti-collision member 3 away from the base 1. The gap 311 allows the adjustment assembly 2 to rotate independently of the anti-collision member 3 without causing the anti-collision member 3 to rotate. The guide post 33 cooperates with the guide hole 12 to further limit the movement of the anti-collision member 3. This allows only axial translational movement until the outer surface of the bumper 3 protrudes relative to the side of the safety seat a.

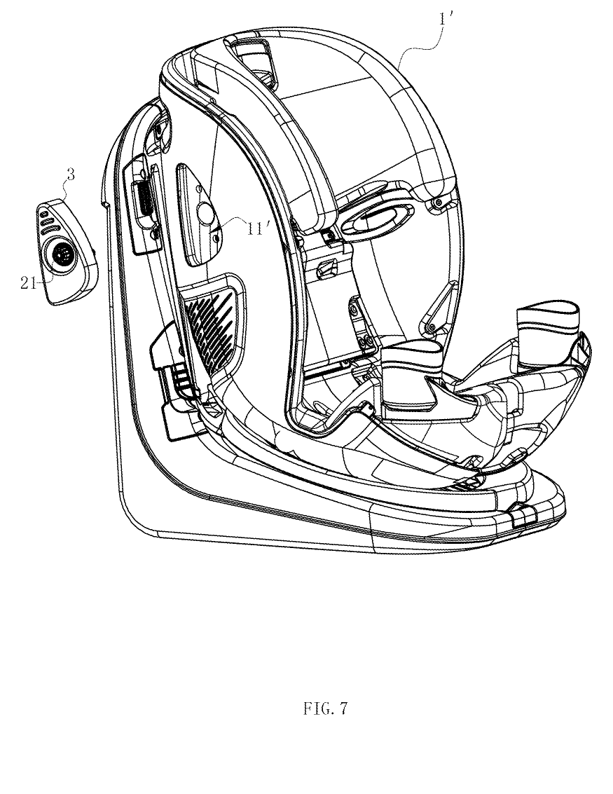

This ensures that, in the event of a side collision, the bumper 3 collides with the vehicle body before the safety seat a, thereby reducing the impact force on the child. 2) Inward Adjustment: The user turns the knob 21 inward, causing the screw 22 to move inward along the internal threads of the screw hole 11. The axial stop structure drives the bumper 3 toward the base 1 until the second stop 222 contacts the outer edge of the screw hole 11, thereby retracting the bumper 3. Example 2: A Child Safety Seat Referring to FIG. 7, the child safety seat of this embodiment includes a seat body 1'. The outer surface of the seat body 1' is provided with the side impact protection device of Example 1. A mounting groove 11' is recessed into the outer surface of the seat body 1'. The side impact protection device is fixedly connected to the bottom of the mounting groove 11'. The walls of the mounting groove 11' conform to the shape of the anti-collision member 3 and are capable of accommodating the anti-collision member 3. When the anti-collision member 3 is adjusted to the closest position to the base 1, the anti-collision member 3 is retracted into the mounting groove 11'. When the user adjusts the anti-collision member 3 outward, the mounting groove 11' conforms to the shape of the anti-collision member 3, and the walls of the mounting groove 11' also limit the rotational movement of the anti-collision member 3, further stabilizing the axial translational movement of the anti-collision member 3.

1. A side impact protection device for a child safety seat in a car, mounted on the outer surface of a safety seat (a), comprising:
a base (1), fixedly connected to the safety seat (a);
an adjustment assembly (2), movably disposed within the base (1); an anti-collision member (3), disposed on the base (1) via the adjustment assembly (2), and capable of adjusting the distance between the anti-collision member (3) and the base (1) via the adjustment assembly (2), thereby adjusting the distance between the anti-collision member (3) and the outer surface of the safety seat (a); characterized in that: The adjusting assembly (2) includes a knob (21) for applying external force and a screw (22) fixedly connected to the knob (21), the base (1) is provided with a screw hole (11) threadedly matched with the screw (22). The knob (21) can drive the screw (22) to rotate along the thread in the screw hole (11). The anti-collision member (3) is provided with a mounting hole (31). The adjusting assembly (2) is movably inserted into the mounting hole (31). An axial limiting structure is provided between the anti-collision member (3) and the adjusting assembly (2). When the external force drives the knob (21) to rotate and causes the screw (22) to rotate along the thread in the screw hole (11), the adjusting assembly (2) drives the anti-collision member (3) to translate axially outward or inward, thereby causing the anti-collision member (3) to move axially away from or close to the base (1).

2. The side impact protection device according to claim 1, characterized in that the axial limiting structure comprises: a first limiting portion (211) arranged in an annular shape, formed by the outer wall of the knob (21) protruding outward in the circumferential direction; a second limiting portion (222) arranged in an annular shape, formed by the end of the screw (22) protruding outward in the circumferential direction near the anti-collision member (3); a gap (23) is left between the first limiting portion (211) and the second limiting portion (222) in the axial direction, and a limiting protrusion (312) protrudes inward on the inner wall of the mounting hole (31) of the anti-collision member (3), and the limiting protrusion (312) is movably locked in the gap (23) between the first limiting portion (211) and the second limiting portion (222).

3. The side impact protection device according to claim 2, characterized in that the outer diameter of the second connecting portion (222) is larger than the diameter of the screw hole (11), and when the anti-collision member (3) is adjusted to the closest position to the base (1), the second limiting portion (222) and the base (1) abut against each other at the outer opening edge of the screw hole (11).

4. The side impact protection device according to claim 2, characterized in that the screw rod (22) protrudes axially at the connection with the knob (21) to form an annular connecting portion (223), the connecting portion (223) is located between the first limiting portion (211) and the second limiting portion (222), and a gap (311) is left between the connecting portion (223) and the limiting protrusion (312) for the adjustment component (2) to rotate relative to the anti-collision member (3).

5. The side impact protection device according to claim 2, characterized in that: the anti-collision component (3) is axially protruded at the periphery of the opening of the mounting hole (31) to form a radial limiting structure (32), and the first limiting portion (211) and the second limiting portion (222) are limitedly matched with the radial limiting structure (32), so that when the knob (21) is driven by external force to rotate and the screw (22) is rotated along the thread in the screw hole (11), the relative positions of the adjustment component (2) and the anti-collision component (3) in the radial direction remain unchanged.

6. The side impact protection device according to claim 5, characterized in that the radial limiting structure (32) comprises: a first limiting convex ring (321), formed by the peripheral edge of the anti-collision member (3) at the opening of the mounting hole (31) protruding axially outward, the inner diameter of the first limiting convex ring (321) matching the outer diameter of the first limiting portion (211), and the outer edge of the first limiting portion (211) abutting against the inner wall of the first limiting convex ring (321); a second limiting convex ring (322), formed by the peripheral edge of the anti-collision member (3) at the opening of the mounting hole (31) protruding axially inward, the inner diameter of the second limiting convex ring (322) matching the outer diameter of the second limiting portion (222), and the outer edge of the second limiting portion (222) abutting against the inner wall of the second limiting convex ring (322).

7. The side impact protection device according to claim 1, characterized in that: a guide post (33) is axially provided on the inner side of the anti-collision member (3) close to the base (1), the base (1) is provided with a guide hole (12) corresponding to the guide post (33), and the guide post (33) is adapted and slidably fitted with the guide hole (12).

8. The side impact protection device according to claim 1, characterized in that: a third limiting portion (224) is formed on the other end of the screw rod (22) close to the anti-collision member (3) and protrudes outward in the circumferential direction, the outer diameter of the third limiting portion (224) is larger than the diameter of the screw hole (11), and when the anti-collision member (3) is adjusted to the state farthest away from the base (1), the third limiting portion (224) and the base (1) abut against each other at the inner opening circumference of the screw hole (11).

9. A side impact protection device according to claim 1, characterized in that: a first connecting hole (212) is provided in the knob (21), a second connecting hole (225) is provided in the screw (22) and is connected to the first connecting hole (212), a fastener (4) is provided at the connection point between the first connecting hole (212) and the second connecting hole (225), and the fastener (4) fixes the knob (21) and the connecting hole (212) so that the two can rotate synchronously.

10. A child safety seat, comprising a seat body (1'), characterized in that: the side impact protection device according to claim 1 is provided on the outer surface of the seat body (1'), a mounting groove (11') is recessed on the outer surface of the seat body (1'), the side impact protection device is fixedly connected to the bottom of the mounting groove (11'), and the groove wall of the mounting groove (11') is adapted to the shape of the anti-collision member (3).
